(19) United States
(12) Patent Application Publication
(10) Pub. No.: US 2022/0080341 A1
(43) Pub. Date: Mar. 17, 2022

(54) NONWOVEN ANTIMICROBIAL AND ANTIVIRAL PROTECTIVE BARRIER

(71) Applicants: Kenneth Keuchel, Solon, OH (US); Destynn Keuchel, Solon, OH (US); Brennen Keuchel, Solon, OH (US); Connor Keuchel, Solon, OH (US)

(72) Inventors: Kenneth Keuchel, Solon, OH (US); Destynn Keuchel, Solon, OH (US); Brennen Keuchel, Solon, OH (US); Connor Keuchel, Solon, OH (US)

(21) Appl. No.: 17/533,952

(22) Filed: Nov. 23, 2021

Related U.S. Application Data
(63) Continuation of application No. 17/322,278, filed on May 17, 2021.
(60) Provisional application No. 63/205,222, filed on Nov. 23, 2020.
(60) Provisional application No. 63/101,793, filed on May 16, 2020.

(51) Int. Cl. B01D 39/16; B01D 46/00; B32B 5/02; B32B 5/26; B01D 46/52

(52) U.S. Cl. CPC B01D 39/1623; B32B 2307/7145; B01D 46/0028; B32B 5/022; B32B 5/028; B32B 5/265; B01D 46/521; B32B 2307/724; B01D 2239/0618; B01D 2239/0622; B01D 2239/0435; B01D 2239/0442; B01D 2239/065; B32B 2250/03; B32B 2250/40; B32B 2262/0253; B32B 2307/20; B01D 46/0032

(57) ABSTRACT

A protective barrier having antimicrobial and antiviral properties. A filtration media structure is constructed from an inner media layer and an outer media layer. The inner and outer layers are spunbond and may be nonwoven or woven. An antimicrobial additive of silver and copper is compounded into a polypropylene base to form each of the layers. A middle layer of melt blown nonwoven filtration media layer may be encapsulated between the inner and outer media layers. The middle layer may also be constructed with the antimicrobial additive of silver and copper for enhanced antimicrobial protection. A channeling layer may also be sandwiched between the inner and outer media layers. The channeling layer comprises a plurality of filaments having a non-round or round cross-section. The filaments are arranged in a three-dimensional (3D) structure configured to disturb laminar flow through the protective barrier and increase contact with the antimicrobial additive.

### CROSS-REFERENCE TO RELATED APPLICATION

The present application claims priority to, and the benefit of, U.S. Provisional Application No. 63/205,222, which was filed on Nov. 23, 2020 and is incorporated herein by reference in its entirety and is also a continuation of U.S. patent application Ser. No. 17/322,278, filed May 17, 2021, which claims the benefit of U.S. Provisional Application No. 63/101,793, which was filed on May 16, 2020 each of which is incorporated herein by reference in its entirety.

### FIELD OF THE INVENTION

The present invention generally relates to a protective barrier, and more specifically to a protective barrier for use in a medical mask, medical gown, or other protective covering constructed with antimicrobial and antiviral properties. Accordingly, the present specification makes specific reference thereto. However, it is to be appreciated that aspects of the present invention are also equally amenable to other like applications, devices, and methods of manufacture.

### BACKGROUND

Germs, bacteria, viruses, microbes, and other pathogens are microscopic living things that exist throughout nature. A pathogen is a type of micro-organism that has the potential to cause disease. Microbes are too small to be seen by the naked eye. Microbes are found in water, soil, and in the air. Some microbes cause illness or disease while others are important for good health. The most common types of microbes are bacteria, viruses, and fungi. A predominant rout of entry into the body is by introducing these pathogens and organisms by inhalation or through mucus membranes. Personal protective equipment, such as a face mask can provide some protection from infection from dangerous micro-organisms.

Viruses are a frequent cause of many infectious diseases. Viruses are made up of one or more molecules surrounded by a protein shell. Transmission of a virus typically occurs directly from person to person, most commonly by inhalation. Some forms of viruses are harmless and only trigger a minor cold, while others can cause serious diseases such as COVID-19 caused by a coronavirus called SARS-CoV-2, influenza, varicella, mumps, measles, and viral meningitis. These viruses are typically spread through respiratory droplets produced when an infected person coughs or sneezes. These droplets can land in the unprotected mouths or noses of people and be inhaled into the lungs. The spread of viruses is more common when people are in close proximity without any protective barrier in place. Face masks are the primary physical barrier typically used to decrease or prevent this type of airborne virus transmission.

Disinfectants and sanitizing agents are used to control transmission of dangerous pathogens in indoor environments. Disinfectants and sanitizers have proven effective at reducing disease causing microorganisms that cause illness on a surface. Unfortunately, the cleaning effect of disinfectants and sanitizers is short lived, being limited to the point when recontamination of the surface occurs or the effective time of the disinfecting or sanitizing agent used. Once a surface is contaminated again, the pathogens will continue to survive until the area is disinfected again. Cloth, or plastic fiber based personal protective equipment (PPE) such as face masks or surgical gowns are not well suited to disinfecting or sanitizing agent due to their construction.

Copper is a known inherently as an antimicrobial material. Copper has the ability to alter the 3-dimensional structure of proteins, form radicals that inactivate viruses, disrupt enzyme structure, interfere with essential elements of a cell, facilitate deleterious activity in superoxide radicals, disturb cell wall permeability causing nutrient uptake to fail, and impair cellular metabolism. Silver has similarly been used as an antimicrobial agent. Silver has the ability to disrupt the metabolic process of bacterial and other microbes thereby preventing nutrient conversion into energy. This inhibits the survival, reproduction, and colonization abilities of these microorganisms.

Medical face masks and barriers are designed to protect a user against contamination from air-borne bacteria, pathogens, particulates, and the like by minimizing the number of air-borne bacteria or pathogens that can penetrate the mask and be inhaled. The current typical construction of medical masks is a three-layer barrier. There are inner and outer layers sandwiching a filtration media. The inner and outer layers are nonwoven moisture resistant plastics while the filtration media is designed to stop the transmission of larger pathogen particles.

Accordingly, there is a great need for an improved protective barrier constructed for use in a medical face mask or other protective barrier configured to better prevent inhalation of harmful air-borne pathogens and viruses. There is also a need for an improve protective barrier constructed with antiviral and antimicrobial properties effective against smaller airborne pathogens transmitted by droplets. Similarly, there is a need for a medical mask constructed from a protective barrier configured with additional surface area for antimicrobial and antiviral materials. Further, there is a need for a need for an antiviral and antimicrobial barrier that does not adversely restrict airflow to a user.

In this manner, the antiviral and antimicrobial barrier of the present invention accomplishes all of the forgoing objectives, thereby improving protection against dangerous microbes and viruses. A primary feature of the present invention is a protective barrier constructed with antiviral and antimicrobial properties effective against smaller airborne pathogens that are transmitted by droplets. The present invention employs an antimicrobial additive to different layers of protective barriers. The present invention increases the surface area of antimicrobial and antiviral materials used in a multi-layer medical face mask or other protective barrier device. Finally, the improved protective barrier of the present invention is capable of reducing inhalation of harmful air-borne pathogens and viruses while not interfering with breathing when used to construct medical face masks.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a protective barrier. The protective barrier is constructed from woven or nonwoven polymer fibers. The protective barrier comprises a filtration media structure. The filtration media structure comprises an inner media layer and an outer media layer. The inner and outer media layers may be spunbond nonwoven media layers or spunbond woven media layers.

The inner and outer media layers are constructed from filaments. The filaments used in the filtration media structure are produced by compounding an antimicrobial additive into a polymerized thermoplastic polymer, such as, a polypropylene base. The antimicrobial additive is an antimicrobial effective amount of copper and silver ions. The resulting product is extruded into a nonwoven structure or used to create a woven layer by calendaring. The protective barrier may then be formed into a face mask or other protective cloth.

The protective barrier may further comprise a middle media layer The middle media layer may be a melt blown nonwoven filtration layer that is encapsulated between the inner and outer spunbond nonwoven media layers. The middle melt blown nonwoven filtration media layer may also be constructed with the antimicrobial additive. Any or all of the inner, outer, or middle media layers may be constructed with the antimicrobial additive.

The middle layer may alternatively be a channeling layer comprising an inner and outer melt blown nonwoven filtration media layers. The channeling layer may further comprise a filament layer constructed from plurality of filaments each having a non-round cross-section arranged in a three-dimensional (3D) structure. The plurality of filaments are sandwiched between the inner and outer melt blown nonwoven filtration media layers. The inner and outer melt blown nonwoven filtration media layers may be constructed with the antimicrobial additive. The plurality of filaments may be constructed with the antimicrobial additive. The plurality of filaments may have a lobe or plus-shaped cross-section.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of a protective barrier of the present invention configured as a medical face mask in accordance with the disclosed architecture.

FIG. 2 illustrates a diagrammatic view demonstrating air flow through the protective barrier of the present invention in accordance with the disclosed architecture.

FIG. 3 illustrates a cross-sectional view of a filament having a round cross-section typically used to construct filtration media for the medical face mask in accordance with the disclosed architecture.

FIG. 4 illustrates a cross-sectional view of a filament having a plus-shaped cross-section used to construct a filtration media structure of the protective barrier of the present invention in accordance with the disclosed architecture.

FIG. 5A illustrates a cross-sectional view of the filament having the plus-shaped cross-section used to construct the filtration media structure of the protective barrier of the present invention in accordance with the disclosed architecture.

FIG. 5B illustrates a cross-sectional view of a filament having a non-round cross-section used to construct the filtration media structure of the protective barrier of the present invention in accordance with the disclosed architecture.

FIG. 5C illustrates a cross-sectional view of a filament having a non-round cross-section used to construct the filtration media structure of the protective barrier of the present invention in accordance with the disclosed architecture.

FIG. 6 illustrates a diagrammatic view demonstrating laminar flow of air around a plurality of filaments having the round cross-section typically used to construct filtration media in accordance with the disclosed architecture.

FIG. 7 illustrates a diagrammatic view demonstrating laminar flow of air around the plurality of filaments having the plus-shaped cross-section used to construct the filtration media structure of the protective barrier of the present invention in accordance with the disclosed architecture.

FIG. 8 illustrates a perspective view of the plurality of filaments arranged in a three-dimensional (3D) structure of the protective barrier of the present invention in accordance with the disclosed architecture.

FIG. 9 illustrates a perspective view of an antimicrobial additive attached to the plurality of filaments arranged in the 3D structure of the protective barrier of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a method to incorporate copper and silver ions within nonwovens to incorporate antimicrobial properties and the resulting protective barrier. Face masks have been used extensively over the last few years to help reduce the spreading of the Corona Virus. A typical disposable face mask is composed of three nonwoven layers: an outer layer, usually spunbond polypropylene, 20-50 gsm; a middle layer of melt blown, usually polypropylene, 20-40 gsm; and an inner layer, closer to the face, which typically another layer of spunbond, typically polypropylene, 20-50 gsm. These layers usually do not have any treatment or ingredients that would be anti-microbial.

Antimicrobial and antiviral additives for plastics work via one of two mechanisms. First, the chemical used for the antimicrobial and antiviral properties can slowly leach out replenishing its surface antimicrobial and antiviral properties until the leaching process is exhausted. This is a time limited process. The second form relies on the bacteria or virus to physically contact the antimicrobial and antiviral material utilizing a dispersion within a matrix material. This process is similar to adding carbon black powder in a thermoplastic to make it black in color. When contact occurs, the bacteria or virus is neutralized because a certain amount of the additive is on the surface of the matrix material.

In the case of medical masks, the matrix material is commonly polypropylene. Additives for thermoplastics for antimicrobial properties such as Microban® are known. Triclosan along with anti-microbial anti-bacterial additive has been successfully used against Methicillin-resistant Staphylococcus aureus (MRSA). Similarly, silver and other metal additives such as copper have been shown to have antimicrobial properties. An anti-viral additive that requires direct physical contact could be similarly disbursed into the fibers of a face mask, or other protective apparel.

Unfortunately, it is challenging to place additives that require direct physical contact with a microbe, bacteria, or virus to be effective directly in the path of the target. In the case of medical masks, the filaments used to create the layers are round in shape. These round filaments allow air to flow around them during inhalation and exhalation. As such, the surface area efficiency of the nonwoven round filament polymer has the lowest surface area per weight ratio.

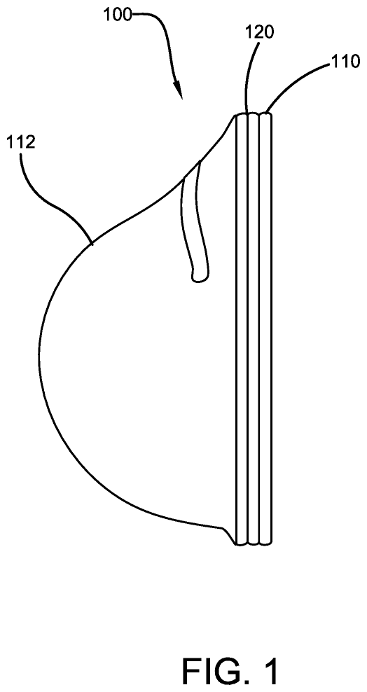

Referring initially to the drawings, FIGS. 1-9, the present invention, in one exemplary embodiment, is a protective barrier 100. The protective barrier 100 is constructed from woven or nonwoven polymer fibers. The protective barrier comprises a filtration media structure. The filtration media structure comprises an inner media layer 110 and an outer media layer 112. The inner and outer media layers 110 and 112 may be spunbond nonwoven media layers or spunbond woven media layers.

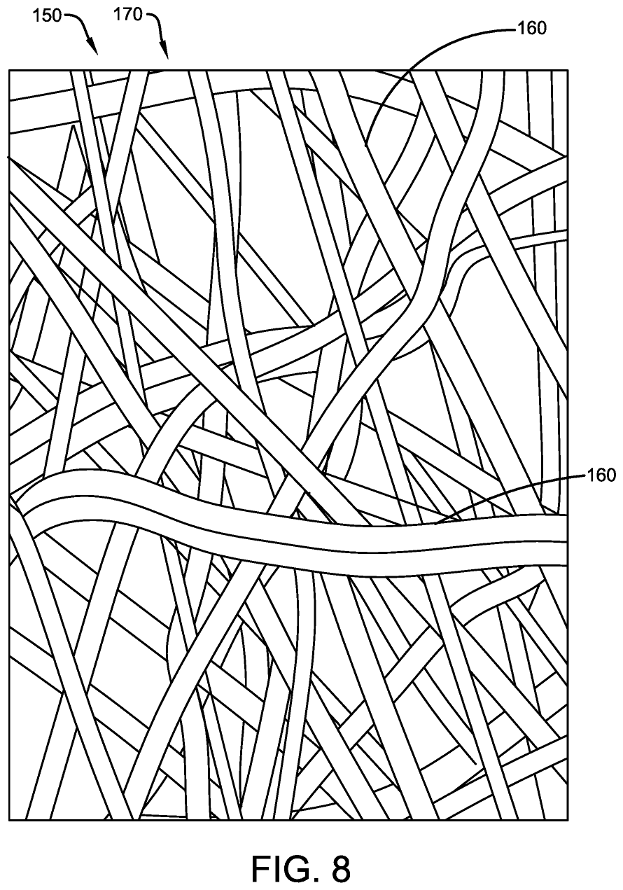

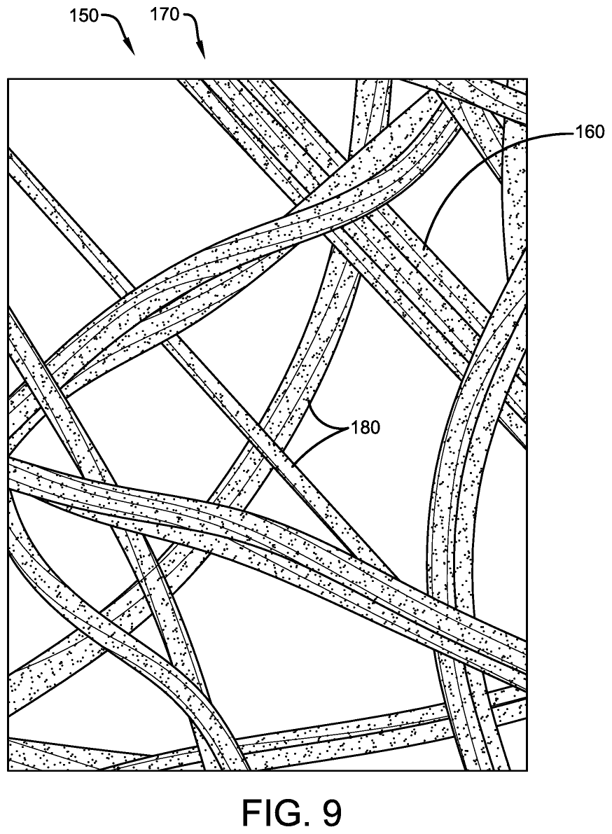

As illustrated in FIGS. 8 and 9, the inner and outer media layers 110 and 112 are constructed from filaments. The filaments used in the filtration media structure are produced by compounding an antimicrobial additive 180 into a polymerized thermoplastic polymer, such as, but not limited to a polypropylene base. However, an embodiment where only one of the inner and outer media layers 110 and 112 is constructed with the antimicrobial additive 180 is contemplated as well. This may then be extruded into a nonwoven structure or used to create a woven layer. It is contemplated to in-line process this by using a compounding single screw or twin screw extruder to provide the melt to a nonwoven process directly. Technically this is combining two processes in to one step. The actual “melt plasticizing” part of the nonwoven process (the extruder, which takes a solid, heat it to a fluid and moves it to the next processing step) can be considered a compounding step. Extrusion does not require a twin screw extruder.

The antimicrobial additive 180 comprises an antimicrobial effective amount of silver, copper, or a combination of both. The antimicrobial additive 180 may be silver ions, copper ions, copper silver ions, or any combination thereof. Copper ionization, silver ionization, and copper silver ionization are preferable for their antimicrobial properties and their ability to be compounded into polymerized thermoplastic polymers. The antimicrobial additive 180 is experimentally effective against Gram-negative and Gram-positive bacteria. Attempts to incorporate cuprous oxide have been challenging. The present invention, in one exemplary embodiment, incorporates an antimicrobial masterbatch called 48515 nShield produced by Americhem having copper and silver ions by compounding the 48515 nShield into a polypropylene base to produce a nonwoven material using an Exxon Achieve polypropylene resin grade as the base polymer. The resulting spunbond nonwoven or woven that may then be flat calendared or point bond calendared. These layers may then be used to construct inner and outer layers of a respirator style face mask.

The nonwoven layers 110 and 112 alone were sent to an outside laboratory and were exposed to staphylococcus aureus and escherichia coli according to testing method AATCC TM100-2019 and were found to have a greater than 99% kill rate. The outside lab showed a 99.9% reduction in E. coli and Staph, after twenty four hours as compared to a cotton strand control fabric. All of the fabrics were initially sterilized (according to the testing standard) at 121 C for 15 minutes, before the testing was conducted.

In an additional experiment, agar was poured into a petri dish. The screening concept was to swab a cloth mask and a mask incorporating silver and copper ions and determine if there were any antimicrobial effects. Agar alone was placed in an 88 degree Fahrenheit oven as a control. A cloth face mask worn for greater than two days was swabbed on the outside with a sterile cotton sway and wiped on an agar petri dish. A third petri dish was prepared wiping the outside of a copper-silver ion mask that was also worn for greater than two days. After two days, the agar alone had no bacteria growing, the copper-silver ion mask had no bacteria growing, and the cloth mask had bacteria growing.

The incorporation in the inner and outer layers 110 and 112 have additional benefits. When someone touches the outer layer 112 to make an adjustment, the eradication of microbes on the outer surface of the outer layer 112 from the antimicrobial properties would reduce the hand transfer of the surface microbes if they were already neutralized.

The protective barrier 100 may further comprises a middle layer 120. The middle layer 120 may be a melt blown woven or nonwoven filtration media layer encapsulated between the inner and outer media layers 110 and 112. The middle layer 120 may also be constructed with the antimicrobial additive 180. The antimicrobial additive 180 can be in any of the layers 110, 112, and 120, spunbond or melt blown, can also be in another type synthetic fiber. Additionally, the layers 110, 112 and 120 can be any woven or nonwoven media that contains copper and silver, such as, but not limited to a carded nonwoven that is made from staple fibers, or a woven on knit fabric whose fibers contain the antimicrobial additives 180.

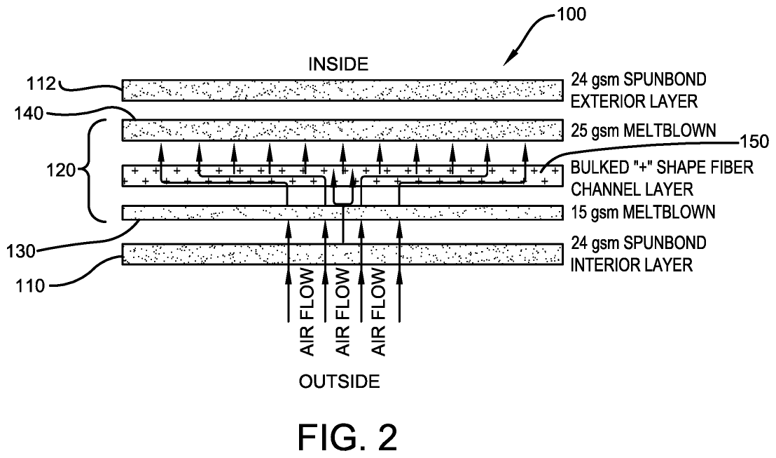

As illustrated in FIG. 2, the middle layer 120 may be a channeling layer. The channeling layer 120, or the inner or outer layers 110 and 112 may be an increased surface area nonwoven polymer fiber barrier for improving direct contact of the fiber surface during airflow. Increasing the surface area of any of the layers 110, 112, and 120 containing the copper and silver is significant. The increased surface area allows for better physical contact between microbes, bacteria, or viruses and the filter material so that an antimicrobial additive on the fiber surfaces can be most effective.

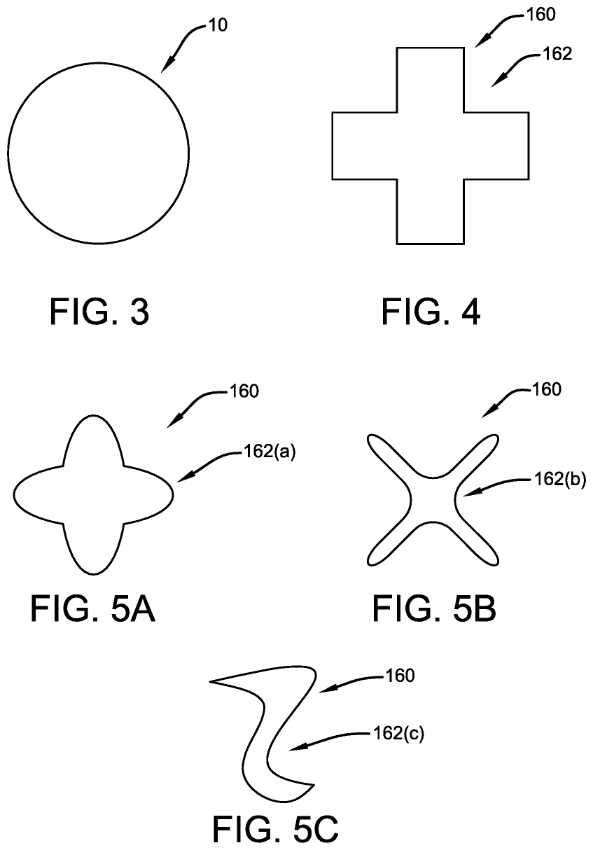

FIG. 3 illustrates an example of a typical fiber 10 used in barrier masks with a round shape or cross-section. To improve the overall surface area available to come in contact with a target bacteria or virus, a shape other than round is preferred, such as a non-round cross-section fiber 162 as illustrated in FIG. 4. In this example, the perimeters of both fibers are different. The perimeter of the plus shaped cross-section fiber 162 of FIG. 4 is approximately 50% larger than the round cross-section fiber filament 10 of FIG. 3, and when multiplied by the equivalent length, would yield a greater surface area of the filament.

The protective barrier 100 is configured to filter out airborne particles including bacteria, viruses, and other microbes. The channeling layer 120 comprises a first filtration media layer 130 and a second filtration media layer 140. The first and second filtration media layers 130 and 140 may be constructed from a melt blown nonwoven material, such as melt blown polypropylene. A melt blown nonwoven material is a material manufactured using a nonwoven manufacturing system involving direct conversion of a polymer into substantially continuous fine filaments, integrated with the conversion of the filaments into a random laid nonwoven fabric. In one example, nonwovens from a carded nonwoven system are used. In this system, bales staple fibers made from polypropylene are opened, randomized and carded into a nonwoven fabric layer. This nonwoven process would be preferable for flooring applications.

The first and second filtration media layers 130 and 140 may alternatively be constructed from nano nonwovens which are typically formed with electrostatic deposition which are highly breathable. There can be other methods to make the media layers. If the melt blown layer also had lobed filament shape, its performance may also be enhanced. The antimicrobial may be incorporated into the melt blown layers with the increased surface area filaments as another enhancement. The first and second filtration media layers 130 and 140 may have similar or different weights. The inner filtration media layer 130 may be lighter than, heavier than, or the same weight as the outer filtration media layer 140. A basis weight of each of the inner and outer melt blown nonwoven filtration media layers 130 and 140 typically ranges from 2 to 80 g/m². It can also be made more open and breathable. Nano nonwoven has shown effectiveness down to 2 g/m². Alternatively, reticulated films with small pores may also be used. This is advantageous for protective barrier applications other than masks, such as medical gowns, disposable floor mats, runners, medical drapes, and the like where reducing surface contact or vapor transmission of microbes is important.

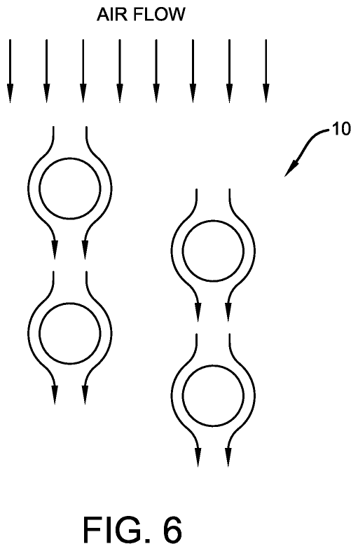

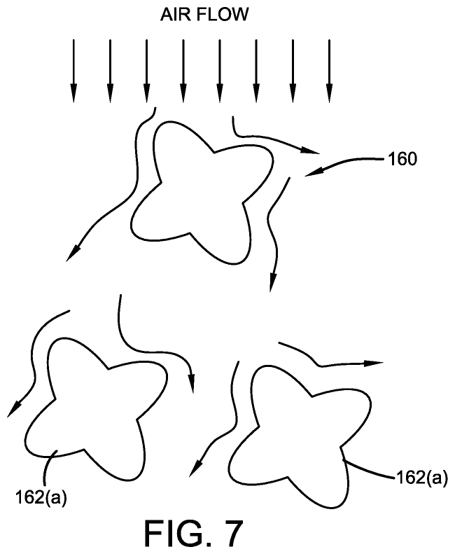

The channeling layer 120 further comprises a filament layer 150 constructed of a plurality of filaments 160 and is sandwiched by or encapsulated between the inner and outer filtration media layers 130 and 140. Each filament 160 is constructed having a non-round cross-section 162. The non-round cross-section 162 may comprise a plus-shape cross-section 162(a) as illustrated in FIG. 5A. The non-round cross-section 162 may alternatively comprise additional non-round cross-sectional filaments 162(b) and 162(c) as illustrated in FIGS. 5B and 5C. Alternatively, each filament 160 may be constructed having a coarse round cross-section 10 with an open and large filament structure as described infra.

The “lobed” or “plus-sign” cross section of the plus-shape cross-section 162(a) filament 160 increases the surface area per weight ratio in comparison to a round cross-section filament 10. Advantageously, this cross-section shape disturbs the laminar flow path around the plurality of filaments 160, deflecting the airborne particulates like a pachinko machine as illustrated in FIG. 7. The deflection of the laminar flow effectively increases direct contact between the filaments 160 and the airborne particles. For comparison, the round cross-sectional filaments 10 produce a more substantially parallel airflow, thereby decreasing direct contact of the filaments 160 with airborne particles as illustrated in FIG. 5 as opposed to a more scattered path airflow.

The filaments 160 are preferably arranged in a three-dimensional (3D) structure 170 that is configured to disturb laminar air flow through the protective barrier 100. The 3D structure 170 may be an open fiber structure, an extruded 3D mesh, pleats, or the like, or any other similar open structure constructed for flow enhancement that allows air to flow less restrictively. The 3D structure 170 is particularly effective at altering airflow when applied between the two layers of the melt blown filtration media 130 and 140.

As illustrated in FIG. 2, placing the plus-shape cross-section 162(a) filaments 160 between the two layers of melt blown nonwoven 130 and 140 creates an unexpected combination of effects. First, the surface area available for direct contact with airborne particles with the plus-shape cross-section 162(a) filaments 160 is increased. This allows the antimicrobial rich filaments 160 a better opportunity to make contact with airborne microbes. This is especially important when there is any antimicrobial that required direct contact with microbes to be effective as discussed infra. Second, this configuration offers a superior 3D shape that allows more air volume between the two layers 130 and 140 as the filaments 160 creates a gap between the two layers 130 and 140. Additionally, providing the channeling layer 120 enhances breathability and air distribution between the filtration media layers 130 and 140, which can also enhance particle filtration efficiency. This shape configuration, which improves available surface area contact and disturb laminar flow, can be effective in any of the layers deployed.

At least one of the two layers of melt blown nonwoven 130 and 140, or the filaments 160 may be constructed with the antimicrobial additive 180. Additionally, the filaments 160 may be constructed with the antimicrobial additive 180. Essentially, any or all of the layers 110, 112, 120, 130, 140, and 150 of the protective barrier 100 may be constructed with the antimicrobial additive 180.

As such, the gap created by the filaments 160 between the two layers 130 and 140 is an antimicrobial gap as the two layers 130 and 140 are physically separated. The two layers of melt blown nonwoven 130 and 140 may also be constructed from non-round cross-section 162 filaments that may be treated with the antimicrobial additive 180. Additionally, the filaments 160 may be separated into a plurality of layers itself to create additional antimicrobial gaps. The “gapping” of the filtration media layers with either just antimicrobial or antimicrobial and flow enhancing or just flow enhancing creates an antimicrobial separation of the layers that effectively decreases surface migration through the layers. This is important as it separates the surface contamination, either from the outside from infecting agents, or from the inside out from an infected patient.

The resulting protective barrier 100 may be configured as a face mask or respirator. On the inside of the mask, the moist environment and bacteria from the exhalation of the wearer provides an incubation environment for bacteria and virus. By neutralizing microbes on the surface of the inner nonwoven (near the face), there is a reduction in risk of an infected wearer transmitting microbes and virus. The risk of respiratory bacterial infections from long term wearing of masks, from the wearer's own bacteria in that warm moist environment, would be mitigated, by the continuous antimicrobial properties of the nonwoven surface. While coating a face mask with an antimicrobial spray has been accomplished, compounding copper and silver ions into the fibers that are used to create the layers has not. An additional benefit to compounding is that some of the copper and silver ions are embedded in the surface.

The resulting protective barrier 100 may be alternatively be configured as a protective gown, surgical gown, or a protective drape. The protective gown or drape could be used in a wide variety of medical or laboratory environments. The resulting protective barrier 100 may be alternatively be configured as a floor mat or runner. Because virus and bacterial particles are heavy and many times on the floor and shoes, this barrier would be also effective in a runner or carpet that can be taken up and replaced. For example, a “walk off mat” could be employed where the amount of virus or bacterial that is on shoes, that could be brought into the hospital or nursing home, could be severely reduced by killing what is on the bottom of the shoe.

Notwithstanding the forgoing, the protective barrier 100 can be any suitable size, shape, and configuration as is known in the art without affecting the overall concept of the invention, provided that it accomplishes the above stated objectives. One of ordinary skill in the art will appreciate that the shape and size of the protective barrier 100 and its various components, as show in the FIGS. are for illustrative purposes only, and that many other shapes and sizes of the protective barrier 100 are well within the scope of the present disclosure. Although dimensions of the protective barrier 100 and its components (i.e., length, width, and height) are important design parameters for good performance, the protective barrier 100 and its various components may be any shape or size that ensures optimal performance during use and/or that suits user need and/or preference. As such, the protective barrier 100 may be comprised of sizing/shaping that is appropriate and specific in regard to whatever the protective barrier 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective barrier comprising:
a filtration media structure comprising:
an inner spunbond nonwoven media layer; and
an outer spunbond nonwoven media layer; and
wherein at least one of the inner and outer spunbond nonwoven media layers are constructed by compounding an antimicrobial additive into a polypropylene base that is calendared.

2. The protective barrier of claim 1, wherein the antimicrobial additive comprises an antimicrobial effective amount of silver and copper.

3. The protective barrier of claim 1, wherein the antimicrobial additive is effective against Gram-negative and Gram-positive bacteria.

4. The protective barrier of claim 1 further comprising a middle melt blown nonwoven filtration media layer encapsulated between the inner and outer spunbond nonwoven media layers.

5. The protective barrier of claim 4, wherein the middle melt blown nonwoven filtration media layer comprises an antimicrobial additive.

6. The protective barrier of claim 5, wherein any of the inner spunbond nonwoven media layer, the outer spunbond nonwoven media layer, or the middle melt blown nonwoven filtration media layer are constructed from a plurality of filaments each having a non-round cross-section to increase a surface area of the layer.

7. The protective barrier of claim 1, wherein the protective barrier is a face mask, a protective gown, a protective drape, or a floor mat.

8. A protective barrier comprising:
a filtration media structure comprising:
an inner media layer; and
an outer media layer; and
wherein at least one of the inner and outer media layers are constructed by compounding an antimicrobial additive into a thermoplastic base that is calendared.

9. The protective barrier of claim 8, wherein the thermoplastic base is a nylon base, a polyester base, or a polyethylene base.

10. The protective barrier of claim 8, wherein the antimicrobial additive comprises an antimicrobial effective amount of silver, copper, or both.

11. The protective barrier of claim 8 further comprising a middle media layer encapsulated between the inner and outer media layers.

12. The protective barrier of claim 10, wherein the middle media layer comprises an antimicrobial additive.

13. The protective barrier of claim 8, wherein the protective barrier is a face mask, a protective gown, a protective drape, or a floor mat.

14. A protective barrier comprising:
a filtration media structure comprising:
an inner spunbond nonwoven media layer;
an outer spunbond nonwoven media layer; and
a channeling layer comprising:
an inner melt blown nonwoven filtration media layer;
an outer melt blown nonwoven filtration media layer; and
a plurality of filaments each having a non-round cross-section arranged in a three-dimensional (3D) structure and sandwiched between the inner and outer melt blown nonwoven filtration media layers; and
wherein at least one of the inner and outer spunbond nonwoven media layers are constructed by compounding an antimicrobial additive into a polypropylene base that is calendared.

15. The protective barrier of claim 14, wherein the channeling layer further comprises an antimicrobial additive attached to each filament.

16. The protective barrier of claim 15, wherein the antimicrobial additive comprises an antimicrobial effective amount of silver and copper.

17. The protective barrier of claim 16, wherein the inner melt blown nonwoven filtration media layer or the outer melt blown nonwoven filtration media layer is constructed from reticulated polypropylene film incorporating the antimicrobial additive.

18. The protective barrier of claim 14, wherein each filament has an increased surface area to weight ratio than a comparable filament having a round cross-section.

19. The protective barrier of claim 14, wherein each filament has a lobe or a plus-shaped cross-section.

20. The protective barrier of claim 14, wherein the protective barrier is a face mask, a protective gown, a protective drape, or a floor mat.
